(19) United States
(12) Patent Application Publication
(10) Pub. No.: US 2006/0244921 A1
(43) Pub. Date: Nov. 2, 2006

(54) Contrast enhancement by selectively using light attenuating modulator

(76) Inventor: Winthrop D. Childers, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/117,189

(22) Filed: Apr. 28, 2005

(51) Int. Cl. G03B 21/26

(52) U.S. Cl. 353/30

(57) ABSTRACT

A system for projecting an image onto a viewing surface comprises a light engine for generating an image-bearing light beam in response to control signals from an image processing unit. The system further includes an attenuating spatial light modulator configured to be selectively positioned in a path of the light beam and further configured to selectively attenuate at least a portion of the light beam when positioned in the path.

### BACKGROUND

Image projection systems are used in a variety of electronic applications, such as front and rear projection televisions, cinemas, and projector units. Many of these systems employ spatial light modulators, such as Digital Light Processing (“DLP”) chips, Liquid Crystal Based Panel Displays (“LCD”), and Liquid Crystal on Silicon (“LCOS)” microdisplays, to modulate light beams before projecting a resultant image onto a viewing medium, such as a television viewing panel, a screen, and a wall. In general, spatial light modulators comprise an array of pixel elements each configured to modulate a portion of a light beam before the light beam impinges upon the viewing medium.

One class of light modulators includes pixel elements that are configured to define “ON” states wherein light defines a spot on the viewing surface and an “OFF” state wherein the light is diverted to a light trap. One issue with all these systems is light leakage during the OFF state and/or during transitions between the ON and OFF states. This light leakage illuminates regions of the viewing surface intended to be black, decreasing a contrast ratio for the system.

Solutions such as variable apertures (to reduce light reaching the screen) can be used to reduce the stray light, but these solutions also decrease intensity of regions of the viewing surface intended to be bright. The embodiments described hereinafter were developed in light of this and other drawbacks associated with known systems.

### BRIEF DESCRIPTION OF THE DRAWINGS

The present embodiments will now be described, by way of example, with reference to the accompanying drawings, in which:

FIG. 1 illustrates a projection system according to an exemplary embodiment;

FIG. 2 is a flow diagram illustrating exemplary steps for selectively positioning an attenuating SLM in an optical path of a light beam, according to an embodiment;

FIG. 3 is a flow diagram illustrating an exemplary method for attenuating a light beam, according to an exemplary embodiment; and

FIG. 4 illustrates a perspective view of a projection system showing an exemplary “dark” frame having a bright or intense portion according to an embodiment.

### DETAILED DESCRIPTION

A projection system for enhancing contrast by reducing stray light while preserving bright regions of an image is provided. The system includes a light engine for generating an image-bearing light beam through a set of projection optics and onto a viewing surface in response to control signals received from an image processing unit. In addition to providing control signals to the light engine, the image processing unit is further configured to analyze the image data so as to determine when to selectively enhance the contrast of the projected image.

In one embodiment the light engine is configured to define an array of spots or pixels on the viewing surface. The apparent intensity of the pixels is defined in part by the duration of ON states of the pixels, that is, a percentage of a frame period during which the pixels are illuminated on the viewing surface. The projection system also includes an attenuating SLM which further includes an array of attenuating elements that are configured to selectively attenuate light from the light engine. For a given image frame, the attenuating SLM can selectively attenuate portions of the pixels by varying amounts.

In one embodiment, the image processing unit selectively positions the attenuating spatial light modulator (SLM) into the light beam when ambient light intensity levels fall below a predetermined threshold. The attenuating SLM is positioned into the light beam by a shuttle mechanism in response to a control signal from the image processing unit. When in the light path, the attenuating SLM selectively attenuates all or part of the light beam to properly display dark scenes that have relatively high intensity sub-regions or objects within them.

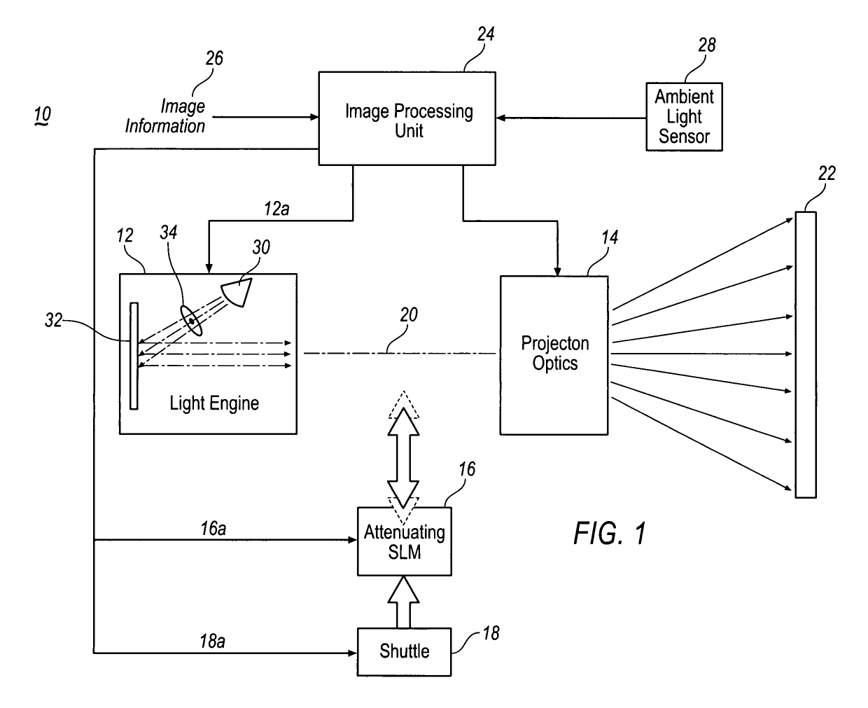

In an exemplary embodiment, FIG. 1 illustrates a projection system 10 including a light engine 12, projection optics 14, and an attenuating spatial light modulator (SLM) 16, which is positionally controlled by a shuttle mechanism 18. The light engine 12 generates a full color, image-bearing light beam cast along an optical path 20 onto a viewing surface 22. An image processing unit 24 is configured to provide control signals to the light engine 12, the SLM 16, and the shuttle 18. The light engine control signals 12a cause the light engine 12 to generate the above-mentioned image-bearing light beam representative of image data received by the image processing unit 24 from a storage medium, such as a DVD, or other source of image data, such as a cable or satellite feed. Control signals 16a selectively attenuate through the SLM 16 all, or only a portion, of the incoming image-bearing light beam to enhance the contrast of displayed image. The shuttle control signals 18a selectively adjust the position of the attenuating SLM 16 through the shuttle mechanism 18. In some embodiments, the system 10 also includes an ambient light sensor 28 in communication with the image processing unit 24 for monitoring the level of ambient light intensity.

The light engine 12 generally includes a light source 30, a spatial light modulator 32, and a color source 34. An exemplary light engine 12 may include, for example, a UHP mercury lamp 30, a digital light processing (DLP) chip 32, and a color wheel 34. Other sources of light, color, and any suitable spatial light modulator, such as a Digital Micromirror Device (DMD), a Liquid Crystal Display (LCD), or a Liquid Crystal on Silicon (LCOS) display may be used.

In an exemplary embodiment, the light modulator 32 is a digital micromirror device that includes an array of mirror elements that each modulate a portion of a light beam. When a mirror element is in an ON state, it defines a spot of light or pixel on viewing surface 22 that corresponds to a location of the mirror element on light modulator 32. When the mirror element is in an OFF state, it deflects light into a light trap (not shown). During a frame period, the apparent intensity of a pixel element on viewing surface 22 is related to a portion of the frame period during which the mirror element is in the ON state. Light modulation using this technique is sometime referred to as “pulse width modulation.” The percentage of the frame period during which the mirror is in the ON state (and hence during which the pixel appears on the viewing surface 22) is sometimes referred to as the “duty cycle” of the mirror element or pixel.

In an exemplary embodiment, the attenuating SLM 16 is configured to be selectively disposed into the optical path 20 of the image-bearing light beam in response to control signals from the image processing unit 24. The attenuating SLM 16 is further configured to have individually controllable regions for attenuating only a portion of a light beam. The individual regions may be individual pixels or groups of pixels, for example.

In an exemplary embodiment, the attenuating SLM 16 is an analog device such as an LCD panel and includes a polarizing element as well. Each attenuating element of the LCD panel is considered to be analog because the degree of attenuation is determined by a voltage level applied to the pixel element. In an exemplary embodiment, each attenuating element of the LCD panel affects the resultant average intensity of a sub-array of an array of pixels being generated on the viewing surface. Stated another way, each attenuating element of modulator 16 modulates the average intensity of a portion of an image generated by light engine 12.

The image processing unit 24 is configured to receive incoming image information 26, and, in some embodiments, information from ambient light sensor 28. The image processing unit 24 is configured to determine whether or not the ambient light is low enough to allow contrast enhancement to provide a net benefit. The image processing unit 24 responds to an ambient light level below a certain threshold by sending control signals 18a to shuttle 18. In some embodiments, the threshold level at which the image processing unit responds is approximately the intensity level of stray light generated by the light engine 12. Shuttle 18 responds to the control signals 18a by positioning or moving SLM 16 into optical path 20

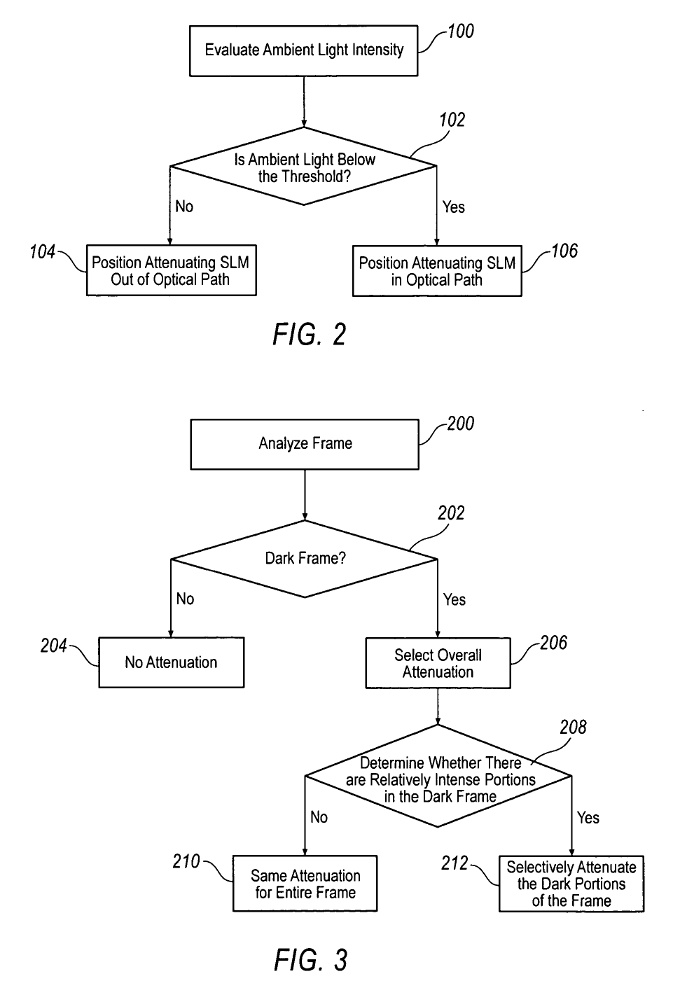

FIG. 2 is a flow diagram illustrating a set of exemplary steps for selectively positioning the attenuating SLM 16. References to physical components refer to the exemplary components illustrated in FIG. 1. At step 100 of FIG. 2, the image processing unit 24 evaluates the level of ambient light intensity based upon input from ambient light sensor 28. At step 102, the image processing unit 24 determines whether the level of ambient light is below a predetermined threshold. If the ambient light is above the threshold level, the attenuating SLM 16 remains out of the optical path 20 (step 104). If the ambient light is below the threshold level, the image processing unit 24 sends a control signal 18a to the shuttle mechanism 18 to position the attenuating SLM 16 into the optical path 20 (step 106).

Once the attenuating SLM 16 is positioned in the optical path 20, it can be used to attenuate the entire image-bearing light beam, or it may be used to attenuate portions (or sub-regions) of the image-bearing light beam. It may be useful to attenuate the entire image-bearing light beam if the image being projected is generally on the “dark” side. If, however, the overall image is “dark,” but there are portions of the image that are bright (or intense)—such as, for example, where the image is of a bright full moon against an otherwise dark sky—it may be useful to selectively attenuate the dark portions of the image-bearing light beam and leave the bright portions unattenuated. It is possible to selectively attenuate portions of the image-bearing light beam on a frame by frame basis.

FIG. 3 is a flow diagram showing an exemplary process for selectively attenuating portions of the image-bearing light beam. At step 200 the attenuating SLM 16 analyzes a given frame of the image-bearing light beam and determines at step 202 whether the image frame is a “dark” frame or dark portion of an image frame. A “dark” frame is an image frame defined as having at least a portion of the frame having an average intensity for one or more colors below a pre-determined threshold. A night scene would be a “dark” scene, but other examples might be a bright scene having a portion that would benefit from contrast enhancement.

One skilled in the art will recognize a number of different ways to determine if a frame is “dark.” For example, the image processing unit 24 could determine that the frame is a “dark” frame if the average pixel intensity of one or more primary colors or the total luminance over the entire frame or a portion of the frame is less than a certain threshold level. Regardless of the method, if the given frame is determined not to have a “dark” portion, there is no attenuation of the light beam (step 204). However, at step 206, if the frame is determined to have a “dark” portion, the image processing unit 24 determines an overall amount to attenuate the entire image-bearing light beam.

One skilled in the art will recognize a variety of acceptable ways to determine a desired attenuation level for an image frame or image frame portion, such as with a histogram analysis. With a histogram analysis, the image processing unit 24 generates information indicative of the distribution of luminance (or brightness of individual primary colors) in the form of a histogram. When it is determined that a significant portion of the pixels have values that are below a certain threshold (such as 50% maximum intensity or 25% maximum intensity or 12% maximum intensity for example) then an overall level of attenuation for the image frame (or portion of image frame) can be utilized.

At step 208, the image processing unit 24 determines if one or more portions of the frame are significantly brighter or more intense than the overall frame. If there are no intense portions in the frame, then the overall desired attenuation level is applied to the entire frame (step 210). For example, the image processing unit 24 causes all or substantially all of the pixels in the attenuating SLM 16 to attenuate their respective portions of the image-bearing light beam to the desired level. If it is determined that there is one or more intense portions in the otherwise dark frame, then the attenuation level of the pixels on the SLM 16 corresponding to the intense portion(s) of the frame is reduced (step 212). In this way, the portion of the image-bearing light beam associated with the dark portion(s) of the frame is attenuated while the remaining intense portion of the frame is left unattenuated, or, alternatively, attenuated less than the dark portion of the frame.

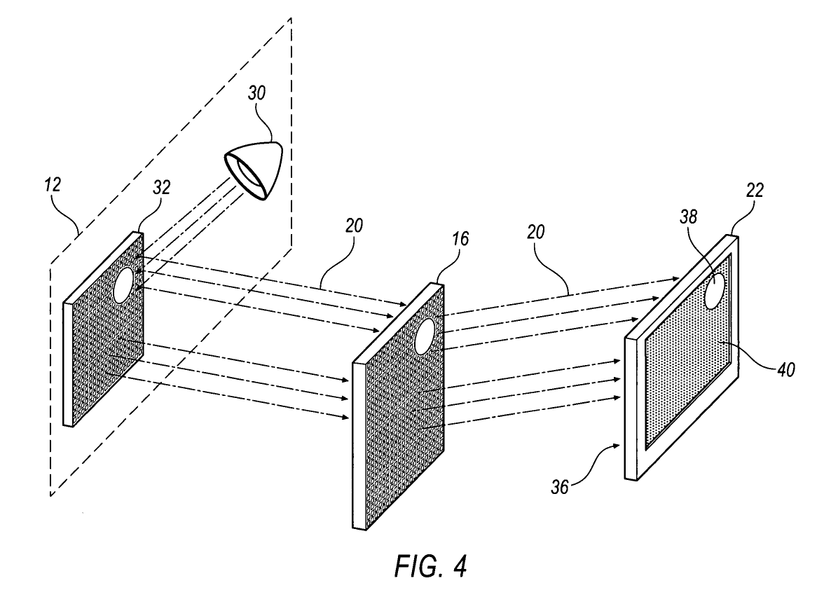

FIG. 4 illustrates an exemplary “dark” frame having a relatively bright or intense portion according to the process as shown in FIG. 3. References to physical components not shown in FIG. 4 refer to exemplary components illustrated in FIG. 1. The embodiment illustrated in FIG. 4 assumes that the level of ambient light intensity is below a threshold. As a result, the attenuating SLM 16 is positioned into the optical path 20 of the image-bearing light beam. As previously described in detail above, the light engine 12 generates an image-bearing light beam onto the attenuating SLM 16, which is configured to individually control portions of the image-bearing light beam in response to control signals 16a from the image processing unit 24. In this way, the attenuating SLM 16 selectively attenuates “dark” portions of the image bearing light beam while leaving the brighter, or otherwise intense portions of the light beam unattenuated—or at least less attenuated than the dark portions. The displayed image 36 in FIG. 4 represents a single frame of the image-bearing light beam illustrating, for example, the image of a bright full moon 38 against an otherwise dark sky 40. In response to control signals 16a from the image processing unit 24, the SLM 16 selectively attenuates the pixels in the dark portion 40 of the frame while leaving the pixels in the bright portion 38 of the frame unattenuated. In this way, the contrast is enhanced between the dark portion 40 and the bright portion 38 of the frame.

The embodiments described herein provide improved contrast for a projection system. Specifically, moving the attenuating SLM 16 into and out of the optical path 20, depending on the overall darkness of a scene, improves contrast during relatively dark scenes and maintains overall brightness during relatively bright or intense scenes. Further, individually controlling the attenuation of portions or sub-regions of the image frame, rather than attenuating the entire image-bearing light beam, provides for enhanced contrast between the dark and intense portions of a scene when ambient light levels are low.

While the present invention has been particularly shown and described with reference to the foregoing preferred embodiment, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and system within the scope of these claims and their equivalents be covered thereby. This description of the invention should be understood to include all novel and non-obvious combinations of elements described herein, and claims may be presented in this or a later application to any novel and non-obvious combination of these elements. The foregoing embodiment is illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A projection system, comprising:
a light engine for generating an image-bearing light beam in response to control signals from an image processing unit; and
an attenuating spatial light modulator configured to be selectively positioned in a path of said light beam.

2. The projection system according to claim 1, wherein said attenuating spatial light modulator is further configured to selectively attenuate less than an entire frame of said light beam.

3. The projection system according to claim 1, wherein said light engine includes a light source and a spatial light modulator, said spatial light modulator is selected from the group: (1) Liquid Crystal Displays (LCD), (2) Digital Micromirror Device (DMD), (3) Liquid Crystal on Silicon (LCOS) and (4) Digital Light Processing (DLP).

4. The projection system according to claim 1, wherein said attenuating spatial light modulator is selected from the group: (1) Liquid Crystal Displays (LCD), (2) Digital Micromirror Device (DMD), (3) Liquid Crystal on Silicon (LCOS) and (4) Digital Light Processing (DLP).

5. The projection system according to claim 1, wherein said attenuating spatial light modulator is configured to have a plurality of individually controllable regions.

6. The projection system according to claim 5, wherein said individually controllable regions are pixels.

7. The projection system according to claim 1, further comprising an ambient light sensor in communication with said image processing unit.

8. The projection system according to claim 1, wherein said image processing unit is configured to monitor the level of ambient light intensity.

9. The projection system according to claim 1, wherein said attenuating spatial light modulator is configured to be selectively positioned into said path of said light beam in response to a control signal from said image processing unit.

10. The projection system according to claim 1, wherein said attenuating spatial light modulator is configured to be selectively positioned in said path of said light beam when a level of ambient light is below a predetermined threshold.

11. The projection system according to claim 1, further comprising a shuttle in communication with said image processing unit wherein said shuttle is configured to position said attenuating spatial light modulator into said path of said light beam upon receiving a control signal from said image processing unit.

12. The projection system according to claim 11, wherein said shuttle is configured to move said attenuating spatial light modulator into said path when a level of ambient light is below a predetermined threshold.

13. The projection system according to claim 11, wherein said shuttle is configured to move said attenuating spatial light modulator out of said path when a level of ambient light is above a predetermined threshold.

14. A method for enhancing image contrast in a projection system, comprising the steps:
determining if an ambient light level is below a threshold level; and
selectively positioning an attenuating spatial light modulator in a path of an image-bearing light beam when said level of ambient light is below said predetermined threshold.

15. The method of claim 14, wherein said positioning step comprises applying a control signal to a shuttle to cause said shuttle to position said attenuating spatial light modulator.

16. The method of claim 14, further comprising the step:
attenuating a relatively dark portion of said light beam while maintaining a relatively intense portion of said light beam substantially unattenuated.

17. A method for enhancing image contrast in a projection system, comprising the steps of:
determining whether a relatively dark frame includes substantially intense portions; and
selectively attenuating said dark portions of said frame relative to said substantially intense portions of said frame.

18. The method of claim 17, wherein said selective attenuation step comprises adjusting an attenuation level of at least one pixel associated with said dark portions.
